(19) United States
(12) Patent Application Publication
(10) Pub. No.: US 2006/0230304 A1
(43) Pub. Date: Oct. 12, 2006

(54) Frequency control method and information processing apparatus

(75) Inventor: Toshitaka Sanada, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/449,595

(22) Filed: Jun. 9, 2006

Related U.S. Application Data
(63) Continuation of application No. PCT/JP04/18841, filed on Dec. 16, 2004.

(30) Foreign Application Priority Data
Dec. 19, 2003 (JP) 2003-422549

(51) Int. Cl. G06F 1/04

(52) U.S. Cl. 713/600

(57) ABSTRACT

According to one embodiment, a method of controlling an operating frequency of a control unit of an apparatus having the control unit for controlling processing operation, includes accepting designation of an upper limit value of the frequency, calculating a value of the frequency in accordance with a type of processing operation, comparing the value of the frequency and the upper limit value, and when the value of the frequency is smaller than the upper limit value as a result of comparison, controlling to operate the control unit at an operating frequency having the value calculated, and controlling to operate the control unit at an operating frequency having the upper limit value when the value of the frequency is not smaller than the upper limit value.

### CROSS-REFERENCE TO RELATED APPLICATIONS

This is a Continuation Application of PCT Application No. PCT/JP2004/018841, filed Dec. 16, 2004, which was published under PCT Article 21(2) in Japanese.

This application is based upon and claims the benefit of priority from Japanese Patent Application No. 2003-422549, field Dec. 19, 2003, the entire contents of which are incorporated herein by reference.

### BACKGROUND

1. Field

One embodiment of the invention relates to a frequency control method of controlling the clock frequency of an information processing apparatus such as a personal computer, and an information processing apparatus.

2. Description of the Related Art

The consumption amount of driving power of an information processing apparatus such as a notebook personal computer (notebook PC) has conventionally increased in proportion to the clock frequency of the CPU. In order to suppress wasteful consumption of driving power of a notebook PC when the notebook PC operates by driving power supplied from the battery, the clock frequency of the CPU is increased in a heavy-load process in, for example, activating or ending an OS (Operating System), and decreased in a light-load process. The technical contents are disclosed in, e.g., Jpn. Pat. Appln. KOKAI Publication No. 2001-5661.

In order to suppress consumption of driving power of the notebook PC because the battery of the notebook PC is going dead, the notebook PC controls to switch the clock frequency of the CPU to a clock frequency designated by the user regardless of the type of processing operation of the OS. The technical contents are disclosed in, e.g., Jpn. Pat. Appln. KOKAI Publication No. 11-73237.

Whether the AC adapter is connected to the notebook PC is determined, and when no AC adapter is connected, i.e., the notebook PC operates by only driving power from the battery, the notebook PC operates at a clock frequency lower than that in connection to the AC adapter. The technical contents are disclosed in, e.g., Jpn. Pat. Appln. KOKAI Publication No. 6-301647.

According to the methods disclosed in Jpn. Pat. Appln. KOKAI Publication Nos. 11-73237 and 6-301647, consumption of driving power from the battery can be reduced by decreasing the clock frequency of the CPU, as needed. However, the clock frequency is kept constant regardless of the type of processing operation of the OS. Unlike the method disclosed in Jpn. Pat. Appln. KOKAI Publication No. 2001-5661, no clock frequency changes in accordance with processing operation of the OS. When a given clock frequency is set and a process requiring no heavy load is performed, the clock frequency is held high for processing operation. In this case, driving power from the battery is wastefully consumed.

The method disclosed in Jpn. Pat. Appln. KOKAI Publication No. 2001-5661 is advantageous in efficiency because the notebook PC can set a necessary clock frequency in accordance with necessary processing operation. However, for example, in order to further suppress power consumption in battery driving, the user wants to give priority to a long battery life rather than a high operating speed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an example of an internal configuration of a notebook PC according to the embodiment of the present invention;

FIG. 2 is a view showing an example of the outline of a sequence of designating an upper limit value of a clock frequency of the CPU 1 by the notebook PC having the configuration shown in FIG. 1;

FIG. 3 is a flowchart showing an example of processing contents regarding designation of a power-saving level by the notebook PC having the configuration shown in FIG. 1;

FIG. 4 is a flowchart showing an example of processing contents via an OS interface of a BIOS shown in FIG. 2;

FIG. 5 is a flowchart showing an example of processing contents via a core of the BIOS shown in FIG. 2;

FIG. 6 is flowcharts showing an example of a contents of a process of switching the clock frequency of the CPU 1 shown in FIG. 1;

FIG. 7 is flowcharts showing an example of a contents of a process of reading out the clock frequency of the CPU 1 shown in FIG. 1; and

FIG. 8 is a flowchart showing a modification to a clock frequency control process by the CPU 1 shown in FIG. 1.

### DETAILED DESCRIPTION

Various embodiments according to the invention will be described hereinafter with reference to the accompanying drawings. In general, according to one embodiment of the invention, a frequency control method of controlling an operating frequency of a control unit of an information processing apparatus having the control unit for controlling processing operation, comprises accepting designation of an upper limit value of the operating frequency, calculating a value of the operating frequency in accordance with a type of processing operation by the control unit, comparing the value of the operating frequency calculated and the upper limit value designated, and controlling to operate the control unit at an operating frequency having the value calculated when the value of the operating frequency calculated is smaller than the upper limit value designated as a result of comparison, and controlling to operate the control unit at an operating frequency having the upper limit value when the value of the operating frequency calculated is not smaller than the upper limit value.

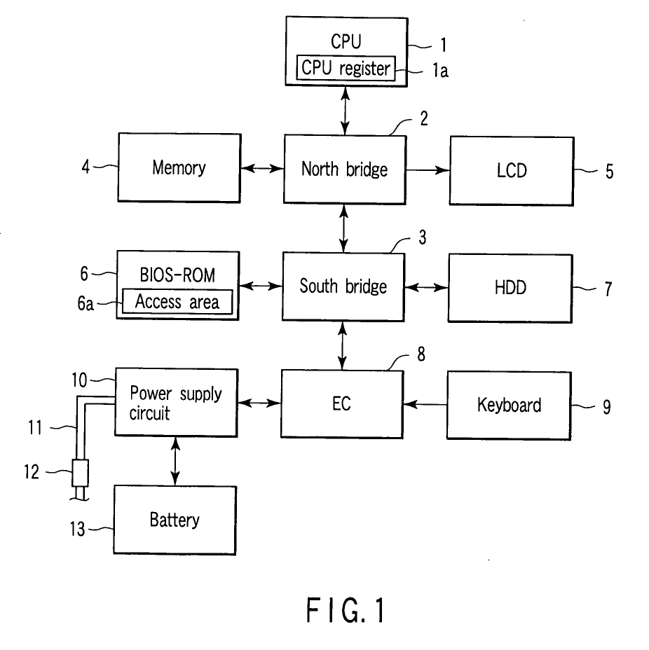

FIG. 1 is a block diagram showing an example of the internal configuration of a notebook PC according to the embodiment of the present invention.

FIG. 1 illustrates only the configuration of a part associated with the present invention in the internal circuit of the notebook PC. The notebook PC according to the embodiment of the present invention comprises a CPU 1 which controls the overall notebook PC. The CPU 1 is connected to a north bridge (to be referred to as an NB hereinafter) 2. The NB 2 is connected to a south bridge (to be referred to as a SB hereinafter) 3.

The NB 2 is a bridge circuit which executes processes such as a data process and address conversion between the NB 2 and the CPU 1 serving as a device connected to the NB 2. The SB 3 is a bridge circuit which executes a data input/output process between devices connected via the SB 3. The NB 2 is connected to a main memory 4 serving as a work memory when the CPU 1 operates. The NB 2 is also connected to an LCD (Liquid Crystal Display) 5 serving as a display device.

The SB 3 is connected to a BIOS-ROM 6 and HDD (Hard Disk Drive) 7. The BIOS-ROM 6 stores programs for basic input/output control of the notebook PC and control of the clock frequency of the CPU 1.

The BIOS-ROM 6 stores control processing programs associated with a process of changing the clock frequency of the CPU 1 in accordance with the type of process executed by the notebook PC and a process of changing the upper limit value of the clock frequency of the CPU 1 in accordance with control by a power-saving utility (to be described later). The BIOS-ROM 6 stores a parameter associated with control of the notebook PC. The control parameter is, e.g., the clock frequency value of the CPU 1. The BIOS-ROM 6 is a memory from which various programs and parameters can be read under the control of the CPU 1.

The CPU 1 incorporates a CPU register 1a for managing the clock frequency of the CPU 1. The CPU 1 operates at a clock frequency managed by the CPU register 1a. The clock frequency value managed by the CPU register 1a is readable/writable under control via the BIOS-ROM 6.

The HDD 7 is a nonvolatile storage medium, and can store data even when the notebook PC is OFF. The HDD 7 stores an OS (Operating System), application programs, and the like. In executing these programs, they are properly expanded in the memory 4. The OS includes the program of the power-saving utility.

The power-saving utility is a program having a function of designating power-saving levels corresponding to upper limit values of the clock frequency of the CPU 1 in accordance with a key input from the user. The power-saving level is represented by, e.g., three stages “high”, “intermediate”, and “low”. These power-saving levels correspond to different upper limit values of the clock frequency. Upon designation of the power-saving level, the CPU 1 operates at the power-saving level and a clock frequency equal to or lower than a corresponding upper limit value.

A bus extending from the SB 3 is connected to an embedded controller (to be referred to as an EC hereinafter) 8. The EC 8 is connected to a keyboard 9. When a key on the keyboard 9 is pressed, the EC 8 detects this press, and outputs a control signal corresponding to the pressed key to the CPU 1.

In selecting the power-saving level, a predetermined operation is done with the keyboard 9 while the notebook PC is ON. The CPU 1 reads out the power-saving utility from the HDD 7, and executes the power-saving utility to display a power-saving level setting window on the LCD 5. The user designates a power-saving level by manipulating the keyboard 9 in accordance with an instruction displayed in the setting window.

The EC 8 is connected to a power supply circuit 10. The power supply circuit 10 is connected to a power plug 12 via a power cord 11. The power supply circuit 10 supplies necessary driving power to each device such as the CPU 1. The power supply circuit 10 is also connected to a battery 13. When no external power can be obtained via the power plug 12, the power supply circuit 10 receives driving power from the battery 13, and supplies the driving power to each device.

A control process for the clock frequency of the CPU 1 of the notebook PC according to the embodiment of the present invention will be explained.

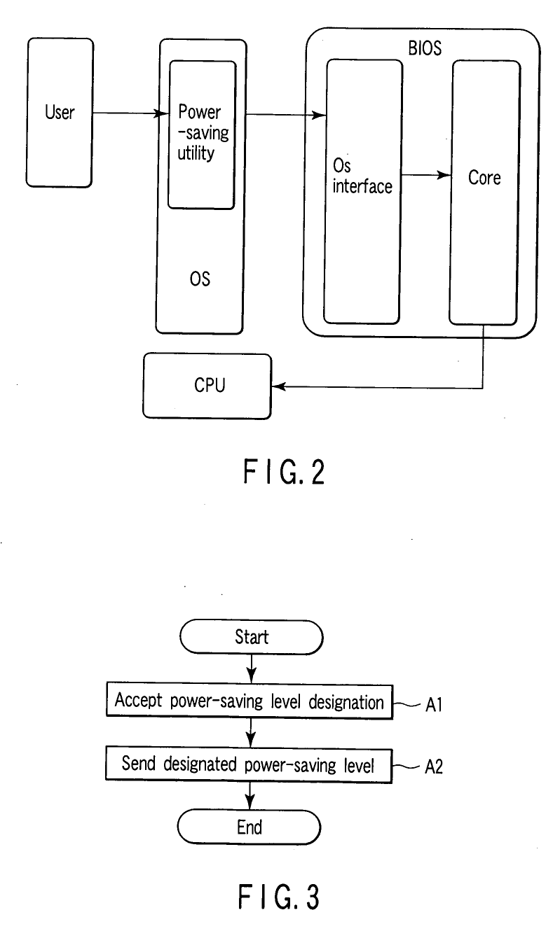

FIG. 2 is a view showing an example of the outline of a sequence of designating the upper limit value of the clock frequency of the CPU 1 by the notebook PC having the configuration shown in FIG. 1.

A BIOS in FIG. 2 is a program stored in the BIOS-ROM 6. The BIOS includes an OS interface serving as a program for performing access to the OS, and a core serving as a program for performing various arithmetic processes.

The user activates the power-saving utility of the OS, and designates a desired power-saving level in accordance with the power-saving level designation window described above. A process concerning the power-saving level shifts from a process by the function of the power-saving utility of the OS to a process by the function of the OS interface of the BIOS.

The notebook PC executes the function of the OS interface of the BIOS, and recognizes the power-saving level designated by the power-saving utility. The process concerning the power-saving level by the notebook PC shifts from the process by the function of the OS interface of the BIOS to a process by the function of the core of the BIOS. The notebook PC executes the function of the core of the BIOS, and derives a clock frequency corresponding to the power-saving level. The clock frequency value is controlled by the CPU 1 so as to correspond to a clock frequency value managed by the CPU register 1a of the CPU 1.

A process from designation of the power-saving level by the user by executing the function of the power-saving utility to calculation of the upper limit value of a clock frequency corresponding to the designated power-saving level via execution of the BIOS will be explained.

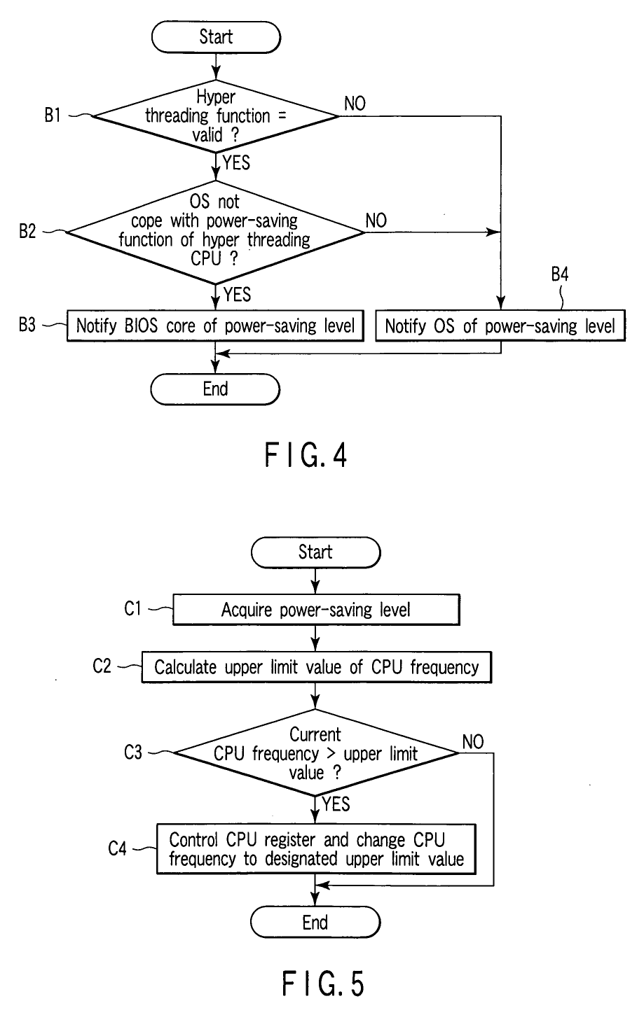

FIG. 3 is a flowchart showing an example of processing contents regarding designation of the power-saving level by the notebook PC having the configuration shown in FIG. 1. FIG. 4 is a flowchart showing an example of processing contents via the OS interface of the BIOS shown in FIG. 2. FIG. 5 is a flowchart showing an example of processing contents via the core of the BIOS shown in FIG. 2.

The CPU 1 activates the power-saving utility of the OS in accordance with a key input from the user. When the user designates a power-saving level in accordance with an instruction in the power-saving level setting window displayed on the LCD 5, the CPU 1 stores data representing the designated power-saving level in the memory 4 (block A1). The CPU 1 reads out a program associated with the OS interface of the BIOS from the BIOS-ROM 6, executes the program, and reads out the power-saving level data stored in the memory 4 by the process of block A1 (block A2). That is, the process concerning the power-saving level shifts from a process by the function of the power-saving utility of the OS to a process by the function of the OS interface of the BIOS.

The CPU 1 has a hyper threading function as a function of executing a plurality of processes at once in appearance. In order to perform a process coping with the hyper threading function by the CPU 1, an OS in the HDD 7 must be a system optimized for the hyper threading function.

Whether to validate or invalidate the hyper threading function can be switched by the user via execution of the BIOS, as needed. As a procedure, the user performs predetermined key operation while the notebook PC is ON. The CPU 1 reads out a BIOS setup program from the BIOS-ROM 6, and displays the BIOS setup window on the LCD 5.

As the next procedure, the user sets whether to validate or invalidate the hyper threading function by manipulating the keyboard 9 in accordance with an instruction displayed in the BIOS setup window. Information representing whether the hyper threading function is valid or invalid is stored in a nonvolatile memory (not shown) such as a CMOS memory.

After the process of block A2, the CPU 1 accesses the BIOS-ROM 6 to determine whether the hyper threading function of the CPU 1 is set valid or invalid (block B1).

If the CPU 1 determines in the process of block B1 that the hyper threading function is set valid (YES in block B1), the CPU 1 reads out the program associated with the OS interface of the BIOS from the BIOS-ROM 6, and executes the program. The CPU 1 determines whether the OS copes with the power-saving function of the hyper threading function of the CPU 1, i.e., whether the OS is a system which realizes designation of the upper limit value of the clock frequency corresponding to the power-saving level when the hyper threading function of the CPU 1 is valid (block B2).

If the CPU 1 determines in the process of block B2 that the OS does not cope with the power-saving function of the hyper threading function of the CPU 1 (YES in block B2), the CPU 1 reads out a program associated with the core of the BIOS from the BIOS-ROM 6 and executes the program so as to allow the BIOS to designate the upper limit value of the clock frequency (block B3). That is, the process concerning the power-saving level shifts from the process by the function of the OS interface of the BIOS to a process by the core of the BIOS.

If “NO” in the process of block B1 or block B2, the CPU 1 executes the OS (block B4). That is, the process concerning the power-saving level shifts from the process by the function of the OS interface of the BIOS to a process by the function of the OS.

The CPU 1 performs the process of block B4 when “NO” as a result of the process of block B2 because of the following reason. When an OS coping with the power-saving function of the hyper threading function is installed in the notebook PC in the future, the processing efficiency will increase in a case in which the notebook PC controls the clock frequency not via the BIOS but via the OS, compared to a case in which the notebook PC controls the clock frequency via the BIOS.

After the process of block B3, the CPU 1 reads out the power-saving level data stored in the memory 4 by the process of block A1 in accordance with the program associated with the core of the BIOS (block C1).

The CPU 1 calculates a parameter corresponding to the power-saving level read out by the process of block C1, i.e., the upper limit value of the clock frequency of the CPU 1. For this calculation, the BIOS-ROM 6 stores data of the highest performance value which is a clock frequency for operating the CPU 1 with the highest performance, and a coefficient corresponding to the power-saving level. The CPU 1 derives a coefficient corresponding to the power-saving level stored in the memory 4 by the process of block A1. The CPU 1 calculates an upper limit value by multiplying the coefficient by the highest performance value, and stores the upper limit value in the memory 4 (block C2).

The BIOS-ROM 6 stores current clock frequency data of the CPU 1 in addition to the upper limit value of the clock frequency. The CPU 1 reads out from the BIOS-ROM 6 the current clock frequency and the upper limit value of the clock frequency that is calculated by the process of block C2. The CPU 1 determines whether the current clock frequency is higher than the upper limit value calculated by the process of block C2 (block C3). The CPU 1 can perform a process of changing the clock frequency of the CPU 1 in accordance with the type of process performed via the OS, which will be described later. At this time, this process is not executed.

If “YES” in the process of block C3, the CPU 1 rewrites clock frequency data of the CPU 1 serving as data stored in the CPU register 1a into upper limit value data of the clock frequency serving as the data calculated by the process of block C2 (block C4). As a result, the CPU 1 operates at a clock frequency having the upper limit value calculated by the process of block C2. After the process of block B4, the CPU 1 performs the same processes as blocks C1 to C4. These processes are executed via the OS.

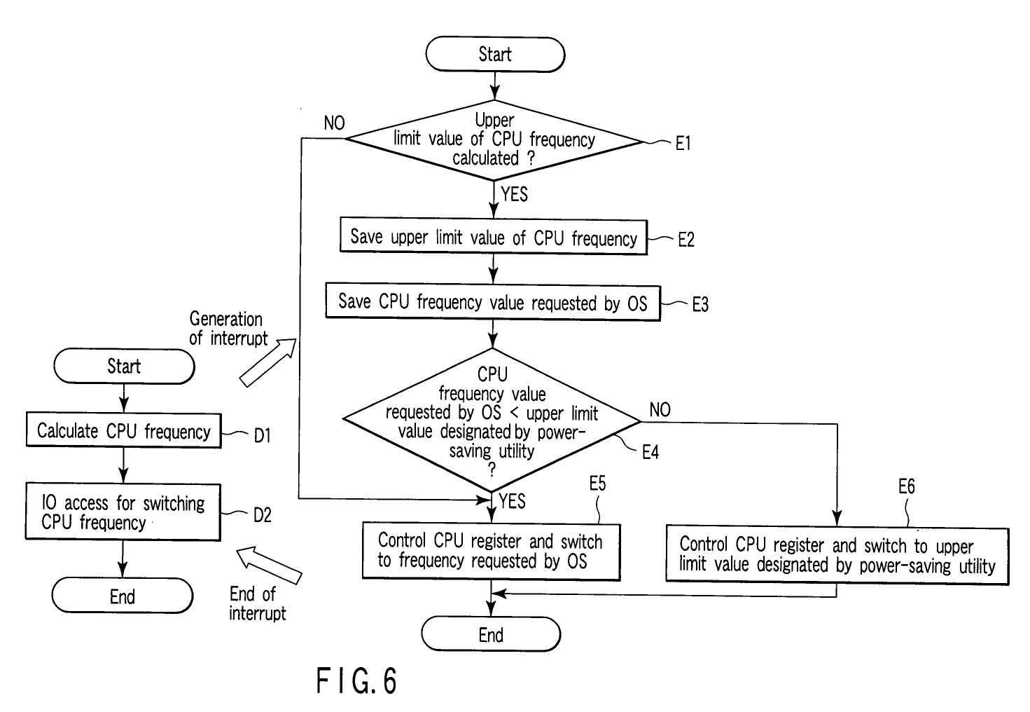

A process of changing the clock frequency of the CPU 1 on the basis of the type of process performed by the notebook PC via the OS and designation of the power-saving level by the power-saving utility will be explained with reference to FIG. 6. FIG. 6 is flowcharts showing an example of the contents of a process of switching the clock frequency of the CPU 1 shown in FIG. 1. Every time a process is done via the OS, the CPU 1 calculates a clock frequency corresponding to the type of process, i.e., a clock frequency as low as possible without decreasing the processing speed (block D1). More specifically, to perform a heavy-load process, the CPU 1 derives a clock frequency higher than a clock frequency necessary to perform another process requiring no standby time.

The CPU 1 accesses the CPU register 1a after address conversion via the NB 2. The CPU 1 rewrites clock frequency data stored in the CPU register 1a into clock frequency data calculated by the process of block D1 in accordance with the type of process of the OS (block D2).

In addition to the processes of blocks D1 and D2, the CPU 1 executes the processes of blocks A1, A2, B1 to B4, C1, and C2 in accordance with designation of the power-saving level described above. When the CPU 1 calculates a clock frequency corresponding to the process of the OS by the process of block D1, the CPU 1 executes the following process as an interrupt process instead of the processes of blocks C3 and C4 in accordance with the program associated with the core of the BIOS without writing the calculation value in the CPU register 1a.

The CPU 1 accesses the BIOS-ROM 6, and determines whether the process of block C2 has been done in advance, i.e., the upper limit value of the clock frequency has been calculated in advance in accordance with designation of the power-saving level by the function of the power-saving utility (block E1). If the CPU 1 determines that no upper limit value of the clock frequency has been calculated (NO in block E1), the CPU 1 performs the process of block E5. The process of block E5 will be described later. If the CPU 1 determines that the upper limit value of the clock frequency has already been calculated (YES in block E1), the CPU 1 reads out upper limit value data of the clock frequency from the BIOS-ROM 6, and writes the data in the memory 4 without performing the process of block D2 (block E2).

The CPU 1 writes in the memory 4 the clock frequency data calculated by the process of block D1 (block E3).

The CPU 1 executes the program associated with the core of the BIOS, and determines whether the clock frequency value which has been calculated by the process of block D1 and written in the memory 4 is smaller than the upper limit value of the clock frequency which has been calculated by the process of block C2 and written in the memory 4 (block E4). That is, in the process of block E4, the CPU 1 determines whether a clock frequency requested by the OS is lower than a clock frequency designated by the power-saving utility.

If “YES” in the process of block E4, the CPU 1 accesses the memory 4 to read out clock frequency data which has been calculated in accordance with the type of process of the OS and written in the memory 4 by the process of block E3. The CPU 1 accesses the CPU register 1a to rewrite the clock frequency data managed by the CPU register 1a into the clock frequency data written in the memory 4 by the process of block E3 (block E5). Accordingly, the CPU 1 operates at the clock frequency calculated in accordance with the process contents of the OS.

If “NO” in the process of block E4, the CPU 1 reads out upper limit value data of the clock frequency that is written in the memory 4 by the process of block E2. The CPU 1 accesses the CPU register 1a to rewrite the clock frequency data managed by the CPU register 1a into the upper limit value data of the clock frequency that has been read out from the memory 4 (block E6). As a result, the CPU 1 operates at the clock frequency calculated in accordance with the power-saving level designated by the user through the power-saving utility. The CPU 1 writes in the memory 4 the clock frequency value calculated by the process of block E3.

The processes from block E1 to block E6 are interrupt processes to the processes of blocks D1 and D2. Of a clock frequency calculated in accordance with the process of the OS and a clock frequency calculated in accordance with a power-saving level designated by the user, a lower clock frequency is reflected as a new clock frequency of the CPU 1.

The clock frequency of the CPU 1 changes in accordance with the type of process of the OS, and the clock frequency value becomes equal to or smaller than an upper limit value calculated in accordance with the power-saving level. Wasteful consumption of driving power can be more efficiently suppressed without decreasing the processing speed more than necessary. For example, when the notebook PC operates not by an external power supply but by driving power supplied from the battery 13, wasteful consumption of driving power can be suppressed even in performing a light-load process.

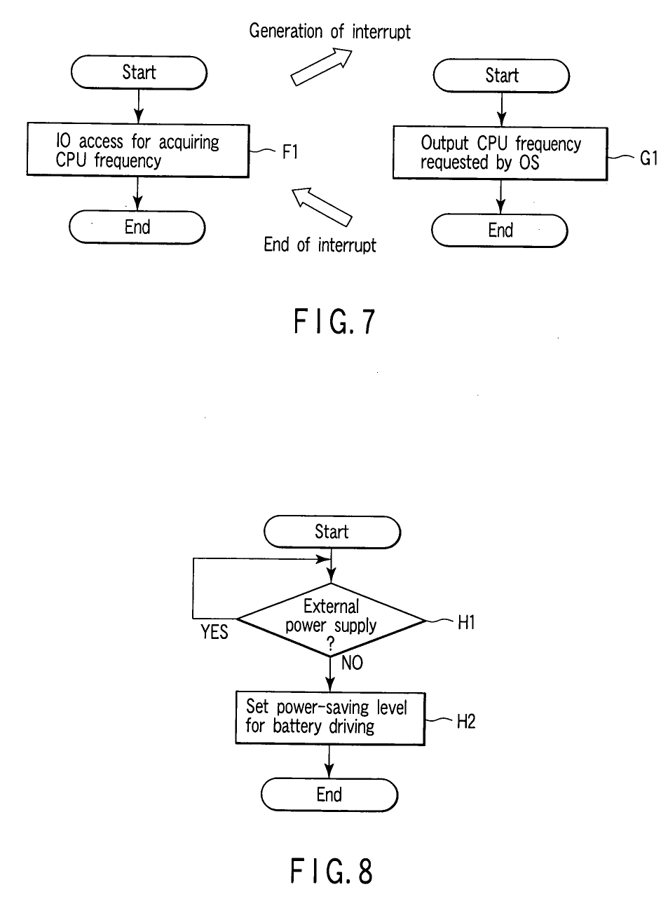

FIG. 7 is flowcharts showing an example of the contents of a process of reading out the clock frequency of the CPU 1 shown in FIG. 1.

After the CPU 1 rewrites a clock frequency managed by the CPU register 1a, the CPU 1 reads out the current clock frequency of the CPU 1 that is data stored in the BIOS-ROM 6. The CPU 1 confirms whether the readout value coincides with a clock frequency value calculated by the process of block D1 (block F1). The read process is performed via the OS. When the clock frequency value has been changed via execution of the BIOS by the process of block E6, the current clock frequency stored in the BIOS-ROM 6 does not coincide with the clock frequency calculated in accordance with the type of process of the OS. In this case, the CPU 1 determines an error.

In order to prevent the error, the CPU 1 executes an interrupt process complying with the program of the core of the BIOS in the clock frequency read process via execution of the OS. In this case, an area subjected to read of the current clock frequency by the CPU 1 is an access area 6a of the BIOS-ROM 6. The area 6a stores clock frequency data written in the CPU register 1a by the process of block E3.

The sequence of the interrupt process will be explained. After the process of block D1, the CPU 1 rewrites clock frequency data stored in the area 6a into clock frequency data saved in the memory 4 by the process of block E3 before the current clock frequency is read out by the process of block F1, i.e., by accessing the access area 6a after address conversion (block G1).

The clock frequency value read out from the area 6a by the CPU 1 is a clock frequency value calculated in accordance with the type of process of the OS by the process of block D1. Hence, the above-mentioned error can be prevented even when the clock frequency value is changed via execution of the BIOS by the process of block E6.

In the above-described embodiment, the user designates a power-saving level through the power-saving utility, and a parameter corresponding to the power-saving level, i.e., the upper limit value of the clock frequency is calculated. However, the sequence is not limited to this. The user may directly designate the upper limit value of the clock frequency within the range of the highest performance value or less via input operation with the keyboard 9 in the power-saving utility.

A modification to the above-described clock frequency control process will be explained. FIG. 8 is a flowchart showing the modification to the clock frequency control process by the CPU 1 shown in FIG. 1.

In this modification, the notebook PC automatically calculates a clock frequency in accordance with whether external power is supplied, and designates the clock frequency as a new clock frequency of the CPU 1, in place of designation of the power-saving level by the user.

The power supply voltage of the external power supply is different from that of the battery 13. The EC 8 detects the value of a power supply voltage applied to the power supply circuit 10, and determines whether external power is supplied (block H1). If external power is determined to be supplied (YES in block H1), the processes of blocks D1 and D2 are done without calculating the upper limit value of the clock frequency.

If no external power is determined to be supplied (NO in block H1), the CPU 1 writes in the memory 4 power-saving level data corresponding to a clock frequency set in advance for battery driving (block H2). Thereafter, the CPU 1 performs the same processes as those in block B1 and subsequent blocks. In the process of block C2, the upper limit value of a clock frequency for battery driving is calculated. In order to suppress consumption of driving power of the notebook PC, the CPU 1 designates, as the upper limit value of the clock frequency, the value of a clock frequency lower than a clock frequency used when external power is supplied.

The CPU 1 performs the process of block E4, and determines a lower clock frequency among a clock frequency calculated in accordance with the type of process of the OS and a clock frequency calculated for battery driving. As a result of determination, the clock frequency calculated in accordance with the type of process of the OS is written in the CPU register 1a by the process of block E5, or the clock frequency calculated for battery driving is written in the CPU register 1a by the process of block E6. Thus, when no external power is supplied to the notebook PC, i.e., the notebook PC operates by driving power of the battery 13, wasteful consumption of driving power can be more efficiently suppressed while the clock frequency is properly changed in accordance with the process of the OS without any special setting by the user.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A frequency control method of controlling an operating frequency of a control unit of an information processing apparatus having the control unit for controlling processing operation, comprising:
accepting designation of an upper limit value of the operating frequency;
calculating a value of the operating frequency in accordance with a type of processing operation by the control unit;
comparing the value of the operating frequency calculated and the upper limit value designated;
controlling to operate the control unit at an operating frequency having the value calculated when the value of the operating frequency calculated is smaller than the upper limit value designated as a result of comparison; and
controlling to operate the control unit at an operating frequency having the upper limit value when the value of the operating frequency calculated is not smaller than the upper limit value.

2. The method according to claim 1, wherein
the information processing apparatus comprises an input unit which accepts input operation regarding the upper limit value of the operating frequency, and the upper limit value of the operating frequency is designated in accordance with the input operation via the input unit.

3. The method according to claim 1, wherein the information processing apparatus comprises a power supply circuit that supplies driving power to the control unit, the method further comprising:
detecting whether external power is supplied to the power supply circuit; and
designating an upper limit value of the operating frequency when external power is detected not to be supplied to the power supply circuit, wherein
the value of the operating frequency calculated and the upper limit value of the operating frequency designated are compared;
the control unit is controlled to operate at the operating frequency having the value calculated when the value of the operating frequency calculated is smaller than the upper limit value designated as a result of comparison; and
the control unit is controlled to operate at an operating frequency having the upper limit value when the value of the operating frequency calculated is not smaller than the upper limit value.

4. The method according to claim 1, wherein the information processing apparatus comprises a storage unit which stores a value of the operating frequency controlled, the method further comprising:
rewriting the value of the operating frequency stored in the storage unit into the value of the operating frequency calculated when the value of the operating frequency stored in the storage unit is different from the value of the operating frequency calculated; and
reading out the value of the operating frequency that is a frequency stored in the storage unit and is rewritten.

5. An information processing apparatus comprising:
a processing unit which controls processing operation;
a calculation unit which calculates a value of an operating frequency in accordance with a type of processing operation by the processing unit;
a designation unit which accepts designation of an upper limit value of the operating frequency;
a comparison unit which compares the value of the operating frequency calculated by the calculation unit and the upper limit value designated by the designation unit; and
a frequency control unit which controls to operate the control unit at an operating frequency having the value calculated by the calculation unit when the value of the operating frequency calculated by the calculation unit is smaller than the upper limit value designated by the designation unit as a result of comparison by the comparison unit, and controls to operate the control unit at an operating frequency having the upper limit value when the value of the operating frequency calculated by the calculation unit is not smaller than the upper limit value.

6. The information processing apparatus according to claim 5, further comprising:
an input unit which accepts input operation regarding the upper limit value of the operating frequency, wherein
the designation unit which accepts designation of the upper limit value of the operating frequency in accordance with the input operation via the input unit.

7. The information processing apparatus according to claim 5, further comprising:
a power supply circuit that supplies driving power to the control unit;
a power detection unit which detects whether external power is supplied to the power supply circuit; and
a second designation unit which accepts designation of an upper limit value of the operating frequency when external power is detected not to be supplied to the power supply circuit by the power detection unit, wherein
the comparison unit which compares the value of the operating frequency calculated by the calculation unit and the upper limit value of the operating frequency designated by the second designation unit, the control unit controls to operate at the operating frequency having the value calculated when the value of the operating frequency calculated by the calculation unit is smaller than the upper limit value designated by the second designation unit as a result of comparison by the comparison unit, and controls to operate at an operating frequency having the upper limit value when the value of the operating frequency calculated by the calculation unit is not smaller than the upper limit value.

8. The information processing apparatus according to claim 5, further comprising:
a storage unit which stores a value of the operating frequency controlled by the control unit;
a rewriting unit which rewrites the value of the operating frequency stored in the storage unit into the value of the operating frequency calculated by the calculation unit when the value of the operating frequency stored in the storage unit is different from the value of the operating frequency calculated by the calculation unit; and
a read unit which reads out the value of the operating frequency that is a frequency stored in the storage unit and is rewritten by the rewriting unit.
